(19) United States
(12) Patent Application Publication
(10) Pub. No.: US 2008/0140884 A1
(43) Pub. Date: Jun. 12, 2008

(54) Canary bit

(75) Inventors: Richard Enbody, East Lansing, MI (US); Krek Piromsopa, East Lansing, MI (US)

Correspondence Address: HARNESS, DICKEY & PIERCE, P.L.C., P.O. BOX 828, BLOOMFIELD HILLS, MI, 48303, US

(73) Assignee: Board of Trustees of Michigan State University, E. Lansing, MI (US)

(21) Appl. No.: 11/973,624

(22) Filed: Oct. 9, 2007

Related U.S. Application Data
(60) Provisional application No. 60/849,879, filed on Oct. 9, 2006.

(51) Int. Cl. G06F 13/14

(52) U.S. Cl. 710/57

(57) ABSTRACT

A computer processor protects a protected word in computer readable memory by employing a canary word in the same buffer as the protected word that is protected by a secure bit and/or by employing a canary bit that directly protects the protected word. A bit setting module marks the protected word as tainted by setting the secure bit or canary bit in response to overwrite of the canary word and/or protected word, including overwrite resulting from overflow of the buffer. A validation module validates non-control data stored in the protected word every time the non-control data is used by a computer process by checking the secure bit of the canary word and/or by checking the canary bit of the protected word.

### CROSS-REFERENCE TO RELATED APPLICATIONS

This application claims priority from U.S. Provisional Patent Application No. 60/849,879 filed on Oct. 9, 2006. The disclosure of the above application is incorporated herein by reference in its entirety for any purpose.

### FIELD

The present disclosure generally relates to buffer overflow protection, and relates in particular to protecting non-control data from buffer overflow attacks by using a secure bit.

### BACKGROUND

Recently, “canary” solutions to buffer-overflow attacks have been implemented in mainstream software. Among the wide variety of canary solutions that exist, the best-known is StackGuard. StackGuard protects against stack smashing by putting a canary word adjacent to a return address. Assuming that overflow occurs in only one direction, validating the canary can detect the overflow of a canary-protected address. Similarly, the concept can also be applied to protect against buffer-overflow attacks on data in general by placing a canary at the end of every buffer or adjacent to each pointer.

Though the mechanism can detect buffer overflow in general, it can be circumvented by replacing the canary word with a valid value when an overflow occurs (see FIG. 2). In addition, there needs to be a mechanism for validating the integrity of the canary word across domains. In other words, a canary word created locally and canary word passing from another domain cannot be differentiated using current techniques.

In contrast, Secure Bit (and similar mechanisms) can preserve the integrity of data across domains. Details relating to Secure Bit can be found in Enbody et al., “Secure Bit,” (WO2006052703A2), filed by the Assignee of the present application on Nov. 3, 2005. Further details relating to Secure Bit, can be found in Enbody et al., “Secure Bit,” U.S. Provisional Patent Application No. 60/650,328, filed by the Assignee of the present application on Feb. 4, 2005. Still further details relating to Secure Bit can be found in Enbody et al., “Secure Bit,” U.S. Prov. Pat. App. No. 60/624,823, filed by the Assignee of the present application on Nov. 4, 2004. The aforementioned patent applications and publication are incorporated herein by reference in their entirety for any purpose.

The Secure Bit mechanism only applies to data which is the target of a jump (including function pointers) because Secure Bit raises an exception when a jump is executed. Secure Bit will not jump to “tainted” (insecure input) data. Non-control data differs because data which is tainted by input may be valid data (e.g. array index). Therefore, Secure Bit cannot be applied directly to protect against buffer overflow on pointers and other non-control data in general. In the case of a pointer (which is not a function pointer), no jump might ever be made to the word storing the pointer. Thus, the need exists for a solution to the problem of protecting against buffer overflow on pointers and other non-control data.

### SUMMARY

In accordance with the present invention, a computer processor protects a protected word in computer readable memory by employing a canary word in the same buffer as the protected word that is protected by a secure bit and/or by employing a canary bit that directly protects the protected word. In another aspect of the present invention, a bit setting module marks the protected word as tainted by setting the secure bit or canary bit in response to overwrite of the canary word and/or protected word, including overwrite resulting from overflow of the buffer. A further aspect of the present invention provides a validation module which operably validates non-control data stored in the protected word every time the non-control data is used by a computer process by checking the secure bit of the canary word and/or by checking the canary bit of the protected word.

The disclosed process and method of protecting non-control data from buffer overflow attacks is advantageous over previous devices and methods because a word created locally and a word passing from another domain can be differentiated and checked whenever the word is used. For example, validating a pointer protected by a canary word, results in checking the validity of the canary word by its secure bit. Alternatively, validating a pointer protected by a canary bit anytime the pointer is used can detect if the pointer is tainted. Validity of the non-control data is tied to the validity of the secure bit which is protected by the secure bit mechanism. The protection is in two ways. First, the bit itself is protected from malicious modification by an attacker. Second, the secure bit protection of control data prevents the attacker from executing code which could circumvent the canary word/bit protection mechanism. As a result, the disclosed protection mechanism(s) cannot be circumvented. Additional advantages and features of the present invention will become apparent from the following description and appended claims, taken in conjunction with the accompanying drawings.

### BRIEF DESCRIPTION OF THE DRAWINGS

The present teachings will become more fully understood from the detailed description and the accompanying drawings, wherein:

FIG. 1 is a block diagram illustrating a computer processor implementing a Canary Word scheme and/or Canary Bit scheme;

FIG. 2 is a graphical representation illustrating vulnerability of a canary word to buffer overflow attack;

FIG. 3 is a graphical representation illustrating comparison of the Canary Word scheme to the Canary Bit scheme;

FIG. 4 is a graphical representation illustrating a snapshot of memory allocation;

FIG. 5 is a graphical representation illustrating memory snapshots with Canary Word without Secure Bit in FIG. 5(a) and with Canary Word with Secure Bit in FIG. 5(b);

FIG. 6(a) is a flow diagram illustrating a method of operation for the Canary Bit scheme; and

FIG. 6(b) is a flow diagram illustrating a method of operation for a Canary Word scheme.

### DETAILED DESCRIPTION OF THE PREFERRED EMBODIMENT

The following description of the preferred embodiment is merely exemplary in nature and is in no way intended to limit the disclosure, its application, or uses.

In accordance with the preferred embodiment of the present invention, the canary solution is a combination of hardware and software solutions. Fundamentally, a tag bit (Secure Bit) is required in hardware for flow tracking. However, there are two different designs for managing the canary: a memory word (or byte) or a hardware bit (in addition to Secure Bit). The first scheme puts greater burden on the software (e.g. compiler). Nonetheless, both can be implemented with hardware and software modifications. These two schemes are referred to as Canary Word and Canary Bit respectively.

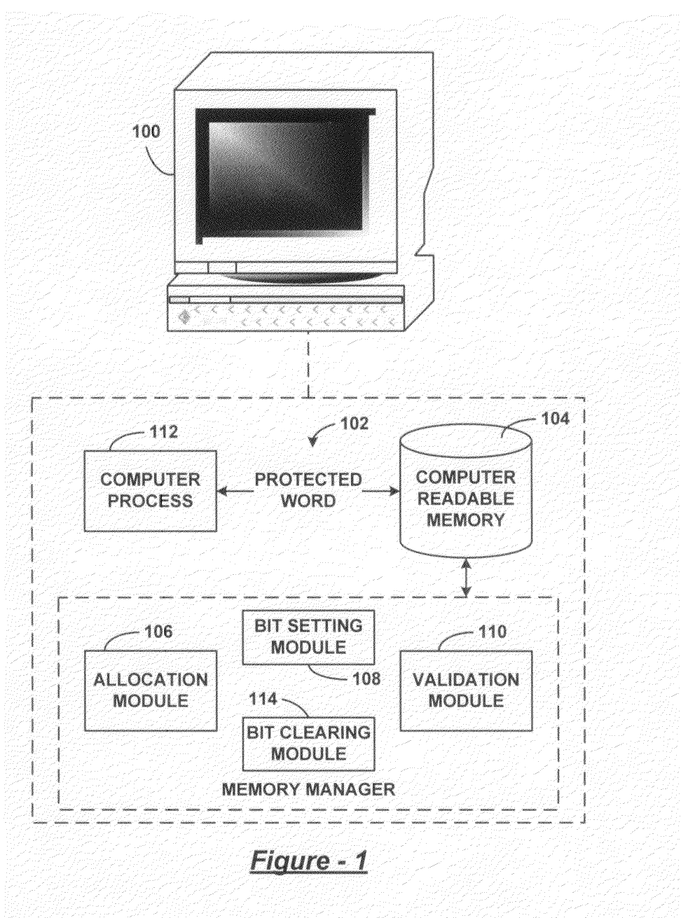

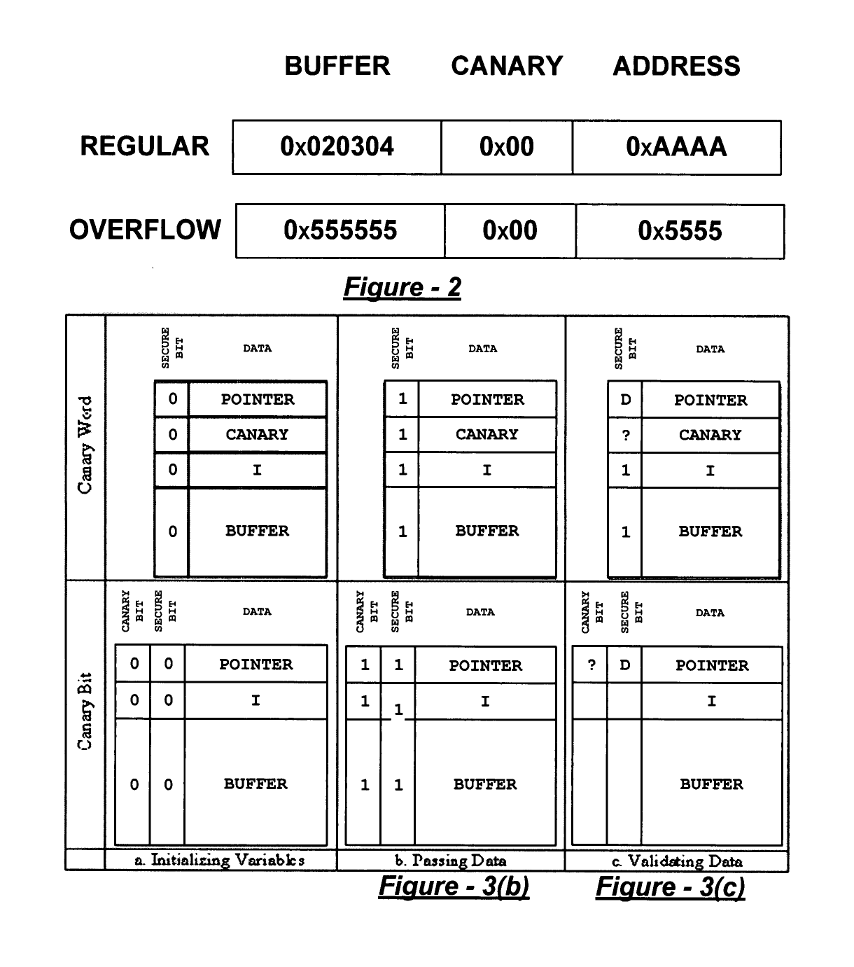

Starting with FIG. 1, a computer processor 100 can implement the canary scheme to protect a protected word 102 in computer readable memory 104. In one embodiment, the computer processor 100 can implement the canary scheme in the form of the Canary Word scheme. In an alternative or additional embodiment, the computer processor 100 can implement the canary scheme in the form of a Canary Bit scheme.

According to the Canary Word scheme, the protected word 102 is protected by a canary word that is in turn protected by a secure bit. Allocation module 106 allocates the canary word in a first memory location of a buffer in the computer readable memory. The canary word protects the protected word in a second memory location of the buffer. The first and second memory locations have a predefined correlation in terms of location within the buffer. Allocation module 106 also allocates the secure bit to the canary word. Bit setting module 108 marks the canary word as tainted by setting the secure bit in response to overwrite of the canary word, including overwrite of the canary word resulting from overflow of the buffer. Validation module 110 validates non-control data stored in the protected word 102 by checking the secure bit of the canary word every time the non-control data is used by a computer process 112. Bit clearing module 114 prevents the secure bit from being cleared unless an entirety of the canary word is also cleared. This prevention ensures that the canary word cannot be untainted, but only cleared.

According to the Canary Bit scheme, the protected word 102 is protected by a canary bit. Allocation module 106 allocates the canary bit to the protected word 102 in a memory location of the buffer in the computer readable memory 104. Bit setting module 108 marks the protected word 102 as tainted by setting the canary bit in response to overwrite of the protected word 102, including overwrite of the protected word 102 resulting from overflow of the buffer. Validation module 110 validates non-control data stored in the protected word 102 by checking the canary bit of the protected word 102 every time the non-control data is used by the computer process 112. Bit clearing module 114 prevents the canary bit from being cleared unless an entirety of the protected word 102 is also cleared. This prevention ensures that data of the protected word 102 cannot be untainted, but only cleared.

To ease understanding, FIG. 3 shows an overview of each scheme. In FIG. 3, ‘?’—indicates data required “Validation”. If the bit is set, an exception is raised. ‘D’—indicates “Don't Care”.

Canary Word: In this scheme, a canary word is inserted adjacent to each pointer (FIG. 3(a) top). If the buffer overflows (upward in this example), the Canary Word will be overwritten when the pointer is overwritten. Similar to Secure Bit, values written into the buffer (including overflow values) get their Secure Bit set (FIG. 3(b) top). Validating the pointer can be accomplished by validating the integrity of the canary word (FIG. 3(c) top). Since data passed from another domain always has its Secure Bit set, detecting the Secure Bit of the canary word will enforce the integrity of the canary word and hence the integrity of the pointer.

Canary Bit: Rather than inserting a word, a similar result can be achieved by using an additional hardware bit (a.k.a. Canary Bit) associated to each pointer for validating the pointer itself (FIG. 3(a) bottom). As with the Canary Word above, values written into the buffer (including overflow values) get their Secure Bit set, but in addition, the Canary Bit will also be set (FIG. 3(b) bottom). As before, validating the pointer can be performed by validating the integrity of the Canary Bit (FIG. 3(c) bottom).

Note that there is a fundamental difference between Secure Bit and Canary Bit. While Secure Bit is associated with data, a Canary Bit is associated with an address (location). For example, in this case moving the pointer value to some different destination will carry along the Secure Bit on the move (with the pointer value) and leave the Canary Bit behind unmodified. (To free a memory location and clear the Canary Bit, a program must explicitly clear a memory entry, e.g. with clear instruction).

Up to this point, the concepts of both schemes have been introduced. The implementations of the schemes are explored below.

The implementation of the schemes builds upon Secure Bit where all input gets its Secure Bit set. To enforce the Canary Word solution, compilers can be modified to inject a canary word adjacent to every pointer (or buffer). Whenever a pointer (or variable) is dereferenced, compiler-injected code forces the program to first validate the Canary Word or Canary Bit.

Pointers are validated by checking the status of the Canary. For both schemes, one instruction is sufficient to validate the Canary. The implementation details of each scheme are disclosed below by elaborating one scheme (Canary Word) and pointing out the small differences for the other (Canary Bit).

With the Canary Word scheme, Secure Bit hardware is sufficient for managing the canary. However, an additional instruction can be required for validating the Secure Bit of the canary word. In terms of software, programs must be modified to include canary words and validate instructions (a compiler can do it).

In regard to memory storage, the hardware storage requirements for Canary Word are similar to that of Secure Bit. In fact, Secure Bit hardware can be used for canary words as well as for its original purpose—they are complementary. If Secure Bit does not already exist, a bit is added to every memory location (and register). This bit is handled by the memory manipulating instructions as a regular memory word (moved along with the associated word). Words in buffers passed between processes get their Secure Bit set. By setting Secure Bit in a buffer passing across domains, associated instructions can easily detect that an address (a canary in this case) was modified by a buffer passing from another domain—there was a buffer-overflow.

Regarding validation, one instruction is sufficient to validate the Secure Bit, and multiple options exist. For example, there exist the options of a new mode, a new instruction, and/or new semantics. These options are described below.

The new mode, “canary mode,” can be added to the processor. In this mode, when a canary word is loaded, its Secure Bit is checked. If the Secure Bit is set, an exception is raised. The mode can be set before loading the canary word and then the mode can be cleared afterwards. An advantage of this mode is that no new instruction is needed; however, a disadvantage is that more instructions are executed.

The new instruction, load-and-validate “LD_VD”, can load and validate a canary word. This instruction is no slower than a regular load instruction because the Secure Bit can be compared in parallel. The pros and cons are the opposite of the new mode above: faster, but the ISA changes.

Choosing new semantics, the conditional branch instruction can be modified to branch or raise an exception if the Secure Bit of a word is found to be set. Some advantages are that the ISA is unchanged and performance is fast. However. a disadvantage is that some convoluted semantics might be necessary. A critical issue with these modifications is that none of them set or clear a Secure Bit. That limitation removes these instructions from any attack vector on the Secure Bit mechanism. When compared with existing schemes such as StackGuard or PointGuard, any of these approaches will be at least as efficient while being more secure.

In addition to the hardware component of the solution described above, there is also a software component. Unlike protecting control data, protecting all pointers requires modification to software. The reason is that control data must be independent of input, whereas some pointers will be modified by input, and only the programmer (compiler) knows the difference. Pointers must be identified and canary words must be placed adjacent to the pointers. This task can be performed either manually by a programmer or automatically by a compiler. A compiler must locate each pointer, insert a canary word adjacent to the pointer, and add an instruction to validate the canary word (see validation options above). When a pointer is dereferenced, if the Canary Bit is found to be set, an exception will be raised.

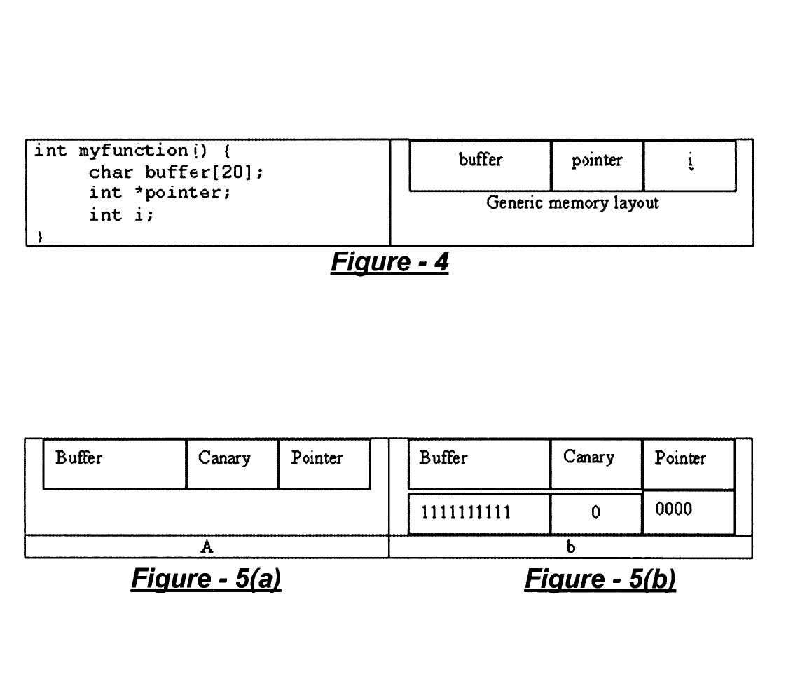

To ease understanding of the mechanism for placing and managing the canary, the concept of how memory is allocated by a compiler is visited here. Normally, local variables are allocated on top of the stack in the order of declaration. FIG. 4 shows a snapshot of memory allocation. Without any protection mechanism, writing beyond the end of a buffer would write over the “next” variables (such as “pointer” and “i” in FIG. 4).

Since overflow goes in one direction, placing a canary adjacent to a pointer provides a mechanism for detecting an overflow to a pointer by validating the value of a pointer (see FIG. 5(a)). However, such a mechanism itself cannot assure the integrity of the canary itself (e.g., overflow without changing the value of the canary). Since overflowing a canary requires modification using input, Secure Bit can be used for validating the integrity of the canary (see FIG. 5(b)). There are two steps: (1) inserting a canary before a pointer; and (2) validating the Secure Bit of the canary before dereferencing a pointer. To archive these goals, either programmers manage the canary or the compiler automatically injects code to the program.

In the case of programmer-managed canary, a variable (e.g. an integer) is declared before each pointer. On any reference to the pointer, the canary must be first asserted (validating that the Secure Bit of the canary is cleared). In the example of Table 1, it is assumed that the function assertSecureBit is responsible for validating the Secure Bit of a memory location. In a similar manner, a compiler can be modified to achieve the same result.

TABLE 1

| | |
|---|---|
| int myfunction ( ) { | int myfunction ( ) { |

| | |
|---|---|
| char buffer[20]; | char buffer[20]; |
| int *pointer; | int canary; |
| int i; | int *pointer; |

| | |
|---|---|
| ... | int i; |

| | |
|---|---|
| *pointer=10; | ... |

| } | _{——}assertSecureBit (&canary); |
|---|---|
| | *pointer=10; |

}

| | |
|---|---|
| Without Canary | With Canary Word |

Possible compiler-injected code in pseudo format is provided below.

| ; _{——}assertSecure Bit (&canary); | |
|---|---|
| LD_VD $pointer—4; | |
| *pointer=10; | |
| LD | $pointer, r1 |
| LD | $10, [r1] |

### Nonetheless, this compiler-supported method requires that the compiler must appropriately (and transparently) allocate a canary next to each pointer.

Now that the implementation of the Canary Word scheme has been detailed above, the differences of the Canary Bit scheme are detailed below. The Canary Bit scheme is similar to the Canary Word, but requires hardware storage in addition to Secure Bit for storing the Canary Bit. Similar to the Canary Word scheme, an additional instruction can be required for validating the Canary Bit of the canary word. Similarly, programs can be modified to manage and validate the Canary Bit.

Regarding memory storage, the hardware requirements for Canary Bit are similar to those of Secure Bit. However, an additional bit is added to every memory entry (word or byte). Words in buffers passed between processes get both their Secure Bit and Canary Bit set. However, the Canary Bit is left unmodified when handled by the memory manipulating instructions (not moved along with the associated word). Thus, a special mechanism is required for initializing and allocating the Canary Bit. One such mechanism can be achieved by modifying the semantics of a “clear” instruction to clear the Canary Bit of a memory entry. By setting the Canary Bit in a buffer passing across domains, associated instructions can easily detect that an address was modified by a buffer passing from another domain—there was a buffer-overflow.

Regarding validation in Canary Bit, the validation protocol is the same as that of the Canary Word scheme. However, regarding the software, with the additional hardware providing the Canary Bit, there is no need for inserting a word adjacent to a pointer—hence no gap for a Canary Word is needed. In addition, since there is no need to verify the adjacent word, there is no additional memory access for loading and verifying the Canary Word. The validation can be performed when the pointer itself is loaded. However, the Canary Bit, unlike Secure Bit, has to be initialized (e.g., to zero) for every memory allocation. With Canary Bit the Canary Word program in Table 1 may look like the pseudo code provided below:

| ; int *pointer; | |
|---|---|
| CLR | $pointer; |
| ... | |

| *pointer=10; | |
|---|---|
| LD_VD | $pointer, r1 |
| LD | $10, [r1] |

Now that the implementations of the two schemes have been described, various options can be explored below. In particular, with either Canary solution in place, other interesting tasks can be performed. For example, this technique allows us to perform hardware-assisted bounds checking. One can place a canary word at the end of a buffer and use the validation instruction to check that the buffer has not gone beyond its bounds. Additionally, one can use a string null terminator as a canary word by associating and validating the Secure/Canary Bit.

Finally, the Canary Bit need not be limited to protecting pointers. Any other critical data can be protected with a canary word. However, using a canary word in such a fashion automatically may not work well in every instance. Thus, some circumstances can benefit from automatic application of the canary word, while others can benefit from manual application of the canary word.

Security is enhanced with respect to other Canary schemes because of the hardware support. Neither the Secure Bit nor Canary Bit can be maliciously modified independent of modifying the protected data. This feature removes an important attack vector. It is believed, but not yet proven, that no attack on the scheme exists.

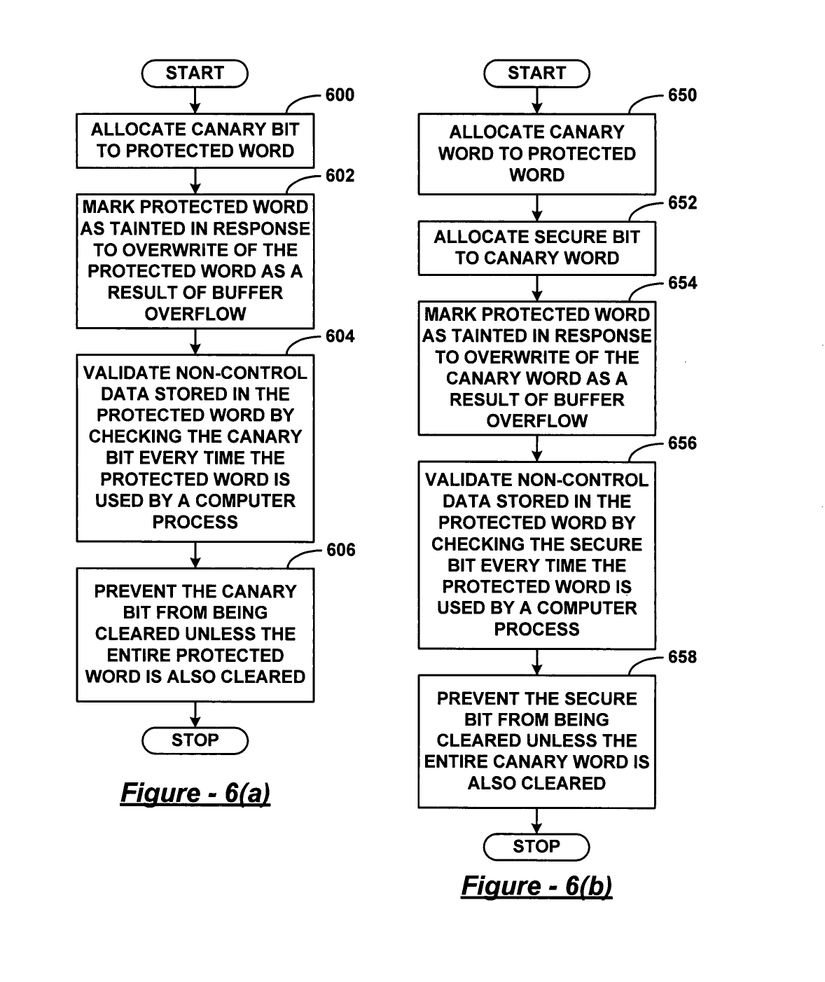

Turning to FIG. 6(a), operation of the Canary Bit scheme can begin by allocating a canary bit to a protected word at step 600. Then, the protected word can be marked as tainted at step 602 by setting the canary bit in response to overwrite of the protected word, including overwrite occurring as a result of buffer overflow. Also, non-control data stored in the protected word can be validated at step 604 by checking the canary bit every time the protected word is used by a computer process. Further, the canary bit is prevented from being cleared at step 606 unless the entire protected word is also cleared.

Turning to FIG. 6(b), operation of the Canary Word scheme can begin by allocating a canary word to a protected word at step 650 in a predefined memory location in the same buffer as the protected word. Thus, when the buffer containing the protected word overflows the canary word will be overwritten. A secure bit allocated to the canary word at step 652 can then be set at step 654 in response to overwrite of the canary word, thus marking the protected word as tainted. At step 656, the protected word is validated by checking the secure bit every time the protected word is accessed by a computer process. The secure bit is prevented from being cleared at step 658 unless the entire canary word is also cleared. In conclusion, Canary Bit can use Secure Bit to protect pointers and other non-control data from buffer overflow attacks.

This disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A computer processor, comprising:
a protected word in computer readable memory that is protected by at least one of:
(a) a canary word that is protected by a secure bit; or
(b) a canary bit;
a validation module validating non-control data stored in said protected word every time the non-control data is used by a computer process, wherein at least one of:
(a) said validation module validates the non-control data by checking the secure bit of the canary word; or
(b) said validation module validates the non-control data by checking the canary bit of said protected word.

2. The computer processor of claim 1, wherein said protected word is protected by the canary bit and said validation module validates the non-control data stored in said protected word by checking the canary bit every time the computer process uses the non-control data, the computer processor further comprising a canary bit allocation module allocating a canary bit to said protected word in a memory location of a buffer in the computer readable memory.

3. The computer processor of claim 2, further comprising a bit setting module marking said protected word as tainted by setting the canary bit in response to overwrite of said protected word, including overwrite of said protected word resulting from overflow of the buffer.

4. The computer processor of claim 2, further comprising a bit clearing module preventing the canary bit from being cleared unless an entirety of said protected word is also cleared, thereby ensuring that data of said protected word cannot be untainted, but only cleared.

5. The computer processor of claim 1, wherein said protected word is protected by the canary word, and said validation module validates the non-control data of said protected word every time the computer process uses the non-control data by checking the secure bit of the canary word, the computer processor further comprising:
a canary word allocation module allocating the canary word in a first memory location of a buffer in the computer readable memory, wherein the canary word protects said protected word in a second memory location of the buffer, the first and second memory locations having a predefined correlation in terms of location within the buffer; and
a secure bit allocation module allocating the secure bit to the canary word.

6. The computer processor of claim 5, further comprising a bit setting module marking the canary word as tainted by setting the secure bit in response to overwrite of the canary word, including overwrite of the canary word resulting from overflow of the buffer.

7. The computer processor of claim 5, further comprising a bit clearing module preventing the secure bit from being cleared unless an entirety of the canary word is also cleared, thereby ensuring that the canary word cannot be untainted, but only cleared.

8. The computer processor of claim 1, further comprising a bit setting module setting the secure bit whenever the canary word is overwritten.

9. The computer processor of claim 1, further comprising setting the canary bit whenever said protected word is overwritten.

10. The computer processor of claim 1, further comprising a bit clearing module ensuring that the secure bit cannot be cleared without clearing an entirety of the canary word.

11. The computer processor of claim 1, further comprising a bit clearing module ensuring that the canary bit cannot be cleared without clearing an entirety of said protected word.

12. A method of protecting non-control data from buffer overflow attacks, the method comprising:
allocating a canary bit to protect a protected word in a memory location of a buffer in a computer readable memory;
marking the protected word as tainted by setting the canary bit in response to overwrite of the protected word, including overwrite of the protected word resulting from overflow of the buffer; and
validating non-control data stored in the protected word by checking the canary bit of the protected word every time the non-control data is used by a computer process.

13. The method of claim 12, further comprising preventing the canary bit from being cleared unless an entirety of the protected word is also cleared.

14. A method of protecting non-control data from buffer overflow attacks, the method comprising:
allocating a canary word in a first memory location of a buffer in a computer readable memory, wherein the canary word protects a protected word in a second memory location of the buffer, the first and second memory locations having a predefined correlation in terms of location within the buffer;
allocating a secure bit to the canary word, thereby protecting the protected word in computer readable memory with the canary word that is protected by the secure bit; and
validating non-control data stored in the protected word by checking the secure bit of said canary word every time the non-control data is used by a computer process.

15. The method of claim 14, further comprising marking the canary word as tainted by setting the secure bit in response to overwrite of the canary word, including overwrite of the canary word resulting from overflow of the buffer.

16. The method of claim 15, further comprising preventing the secure bit from being cleared unless an entirety of the canary word is also cleared, thereby ensuring that the canary word cannot be untainted, but only cleared.

17. The method of claim 14, further comprising preventing the secure bit from being cleared unless an entirety of the canary word is also cleared, thereby ensuring that the canary word cannot be untainted, but only cleared.

18. A method of protecting non-control data from buffer overflow attacks, comprising:
protecting a protected word in computer readable memory with either a canary word that is protected by a secure bit, or a canary bit;
validating non-control data stored in the protected word every time the non-control data is used by a computer process, wherein, in the case of a canary word protected by a secure bit, said validating occurs by checking the secure bit of the canary word, and, in the case of a canary bit, the validation occurs by checking the canary bit of the protected word;
setting at least one of the secure bit or the canary bit whenever the words that they protect, respectively, are overwritten; and
ensuring that at least one of the secure bit or the canary bit cannot be cleared without clearing the entire words that they protect, respectively.

19. The method of claim 18, further comprising:
allocating a canary word in a first memory location of the buffer in computer readable memory, wherein the canary word protects the protected word in a second memory location of the buffer, the first and second memory locations having a predefined correlation in terms of location within the buffer;
allocating the secure bit to the canary word;
marking the canary word as tainted by setting the secure bit in response to overwrite of the canary word, including overwrite of the canary word resulting from overflow of the buffer;
preventing the secure bit from being cleared unless an entirety of the canary word is also cleared, thereby ensuring that the canary word cannot be untainted, but only cleared; and
validating non-control data of the protected word every time the computer process uses the non-control data, wherein said validating includes checking the secure bit of the canary word.

20. The method of claim 18, comprising:
allocating a canary bit to the protected word in a memory location of the buffer in computer readable memory;
marking the protected word as tainted by setting the canary bit in response to overwrite of the protected word, including overwrite of the word resulting from overflow of the buffer;
preventing the canary bit from being cleared unless an entirety of the protected word is also cleared, thereby ensuring that data of the protected word cannot be untainted, but only cleared; and
validating non-control data stored in the protected word by checking the canary bit every time the computer process uses the non-control data.

21. A computer readable medium, comprising:
first executable machine instructions operable to protect a protected word in computer readable memory by allocating to the protected word in a buffer of the computer readable memory at least one of:
(a) a canary word that is protected by a secure bit; or
(b) a canary bit;
second executable machine instructions operable to mark the protected word as tainted by at least one of:
(a) setting the secure bit in response to overwrite of the canary word, including overwrite of the canary word resulting from overflow of the buffer;
(b) setting the canary bit in response to overwrite of the protected word, including overwrite of the protected word resulting from overflow of the buffer; and
third executable machine instructions operable to validate non-control data stored in the protected word every time the non-control data is used by a computer process, wherein at least one of:
(a) said third executable machine instructions validate the non-control data by checking the secure bit of the canary word; or
(b) said third executable machine instructions validate the non-control data by checking the canary bit of the protected word.

22. The computer readable medium of claim 21, wherein said first executable machine instructions are operable to protect the protected word in computer readable memory by allocating to the protected word in the buffer of the computer readable memory the canary word that is protected by the secure bit, said second executable machine instructions are operable to mark the protected word as tainted by setting the secure bit in response to overwrite of the canary word, including overwrite of the canary word resulting from overflow of the buffer, and said third executable machine instructions are operable to validate the non-control data stored in the protected word by checking the secure bit of the canary word every time the non-control data is used by a computer process.

23. The computer readable medium of claim 22, further comprising fourth executable machine instructions operable to ensure that the secure bit cannot be cleared without clearing an entirety of the canary word.

24. The computer readable medium of claim 21, wherein said first executable machine instructions are operable to protect the protected word in computer readable memory by allocating to the protected word in a buffer of the computer readable memory the canary bit, said second executable machine instructions are operable to mark the protected word as tainted by setting the canary bit in response to overwrite of the protected word, including overwrite of the protected word resulting from overflow of the buffer, and said third executable machine instructions are operable to validate non-control data stored in the protected word by checking the canary bit of the protected word every time the non-control data is used by a computer process.

25. The computer readable medium of claim 24, further comprising fourth executable machine instructions operable to ensure that the canary bit cannot be cleared without clearing an entirety of the protected word.
